(19) United States
(12) Patent Application Publication
(10) Pub. No.: US 2012/0000043 A1
(43) Pub. Date: Jan. 5, 2012

(54) TENSIONING DEVICE

(75) Inventor: Paul R. Maire, Snowmass, CO (US)

(73) Assignee: Tie Boss LLC, Minneapolis, MN (US)

(21) Appl. No.: 13/174,085

(22) Filed: Jun. 30, 2011

Related U.S. Application Data
(60) Provisional application No. 61/360,286, filed on Jun. 30, 2010.

(51) Int. Cl. B60P 7/06

(52) U.S. Cl. 24/68 CD

(57) ABSTRACT

A simple and inexpensive device for a reliable tie down tensioning which device enables the tie-down to be quickly and easily applied and the flexible element tensioned and just as quickly and easily removed.

### CROSS-REFERENCE TO RELATED APPLICATIONS

This application claims priority to U.S. Provisional Patent Application Ser. No. 61/360,286 filed Jun. 30, 2010 which, in its entirety, is hereby incorporated herein by reference.

### TECHNICAL FIELD

This invention relates to the tensioning of lines, ropes, webbing, elastic cables, and other flexible elongated elements used to tie down cargo, hoisting, and other similar applications.

### BACKGROUND

This invention relates to a simple and inexpensive device for enabling the tie down of lines, ropes or elastic cables to be quickly and easily attached, tensioned, and reliably fixed in place under tension, while also enabling them to be quickly and easily released. It also relates to a tie down device that maintains tension of the load even upon a sudden and unexpected potential failure of the primary tie down device.

A variety of devices for tie-down tensioning are known in the art. However, such devices have been subject to one or more disadvantages in use. For example, some of the devices of the prior art have made it difficult to adjust the length of the tie-down to size prior to tensioning. This is especially true for those devices incorporating complex and inconvenient ratcheting or cam mechanisms. Most other devices are complicated and expensive to manufacture. Others incorporate sheaves, pins, springs, ratchets, cams, and other small parts that will wear out, potentially fail suddenly and without warning, and not work properly in harsh, muddy, wet, and extremely cold environments.

Furthermore, until now most prior art devices have required the user to engage a special unlocking feature at the device to release the rope tension. Unavoidably, this positions the user in close proximity to the load and provides no easy way to put distance between the user and the potentially harmful affects of releasing the tension.

Other more pressing problems with the prior art relate to potential unintended and catastrophic sudden failure due to inherent design flaws. For example, in most prior art devices the hook is connected to the main tensioning device with some form of rope or strapping. In other devices the hook is fastened directly to the housing. In all these examples, should the housing or mechanism in the housing fail, the load tension will release. Furthermore, there is no back up method for maintaining the tension in such an event.

### SUMMARY

Embodiments of the present invention provide a significantly enhanced mechanism for hoisting loads and performing other similar functions. When tension is introduced to the rope, a larger proportion of that tension is applied toward lifting a load, as opposed to being countered by frictional forces between the rope and the device. In preferred embodiments, the rope passes over a means for reducing friction (e.g., a wheel that rotates) as the rope is moved. In many such embodiments, there is substantially no relative movement between the wheel and the rope. In some embodiments, the resulting device combines the functionality of a pulley and a jamming cleat.

### BRIEF DESCRIPTION OF THE DRAWINGS

FIG. 1 is a perspective view of a prior art tensioning device;

FIG. 2 is a perspective view of a disassembled prior art tensioning device of FIG. 1;

FIG. 3 is a perspective view of a tensioning device in accordance with an embodiment of the invention;

FIG. 4 is a perspective view of a disassembled tensioning device of FIG. 3;

FIG. 5 is a perspective view of a tensioning device in accordance with another embodiment of the invention; and

FIG. 6 is a perspective view of a disassembled tensioning device of FIG. 5.

### DETAILED DESCRIPTION

While multiple embodiments of the instant invention are disclosed, alternate embodiments may become apparent to those skilled in the art. The following detailed description describes only illustrative embodiments of the invention with reference to the accompanying drawings wherein like elements are designated by like numerals. It should be clearly understood that there is no intent, implied or otherwise, to limit the invention in any form or manner to that described herein. As such, all alternatives are considered as falling within the spirit, scope and intent of the instant invention.

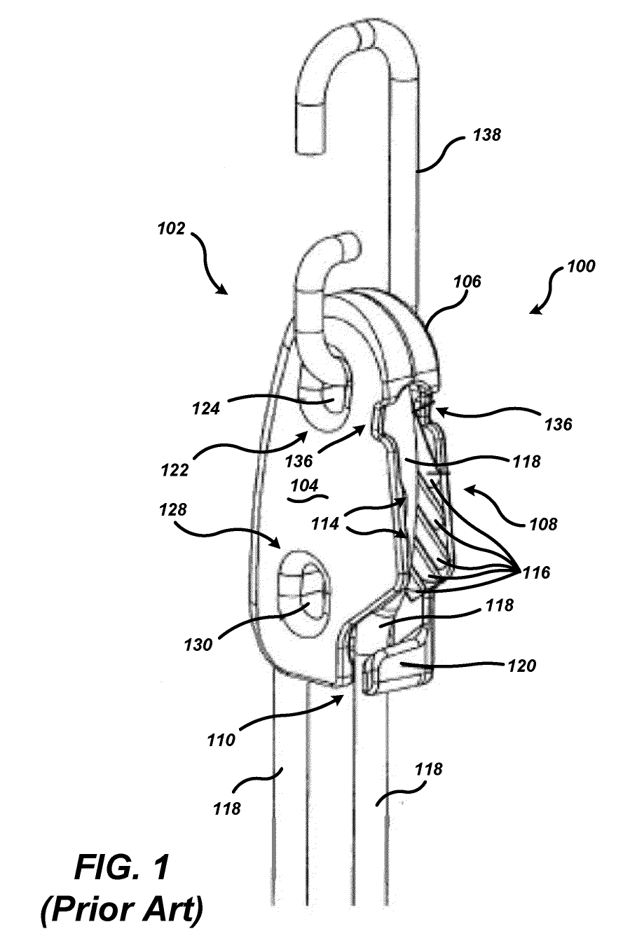

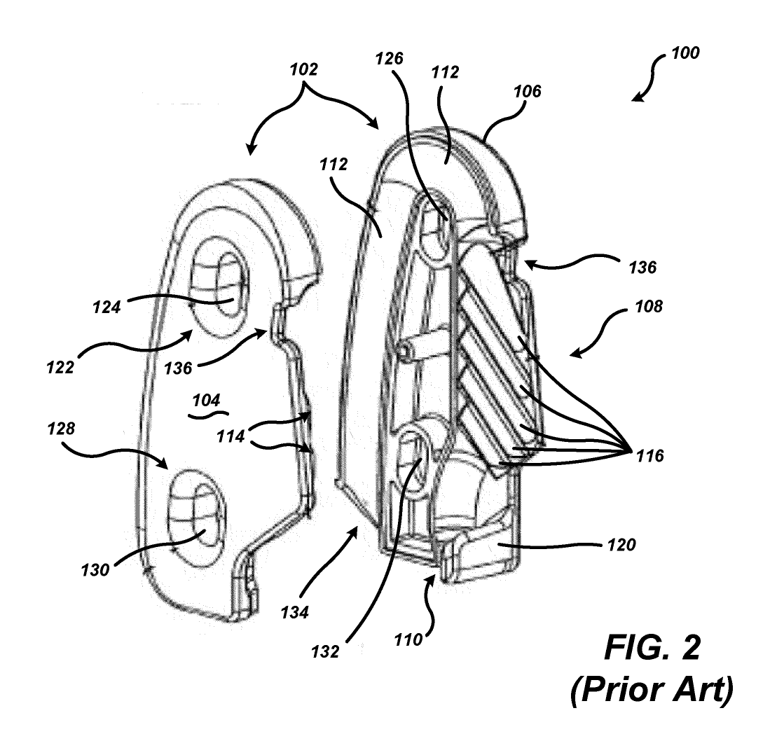

FIGS. 1 and 2, respectively, are perspective views of an assembled and a disassembled prior art tensioning device 100. Detailed descriptions of the features and methods of using tensioning device 100 are provided in co-owned U.S. Pat. No. 7,428,769 and co-owned U.S. Patent Application Publication Nos. 2008/0307612 and 2010/0212116 all of which, in their entirety, are hereby incorporated herein by reference. Briefly, housing 102 of tensioning device 100 comprises two opposed walls 104 and 106. When assembled, opposed walls 104 and 106 together define jamming cleat 108, locking element 110 and channel 112 within housing 102. Jamming cleat 108 comprising a plurality of opposing ridges 114 and 116 in opposed walls 104 and 106, respectively, is configured for imparting a non-slip grip on flexible elongated element 118 therewithin. Locking element 110 comprising locking arm 120 is configured for retaining flexible elongated element 118 within jamming cleat 108 upon placement of flexible elongated element 118 in the space between housing 102 and locking arm 120. Housing 102 further includes at least one aperture 122 extending therethrough, wherein aperture 122 is formed by aligned apertures 124 and 126 in opposed walls 104 and 106, respectively. Alternate embodiments of tensioning device 100 include additional apertures extending through housing 102, such as aperture 128 formed by aligned apertures 130 and 132 in opposed walls 104 and 106, respectively. In the prior art tensioning device 100 illustrated in FIGS. 1 and 2, channel 112 extends through housing 102 between openings 134 and 136 and around the interior surface of aperture 122. As shown, channel 112 functions as a passage for flexible elongated element 118 within housing 102, extending from the first opening 134, through an approximately 180° turn, to the second opening 136. Securing elements, such as removable securing element 138 extending through aperture 122 in housing 102, are used for attaching tensioning device 100 to a substantially fixed object for the purpose of tensioning flexible elongated element 118.

In use, channel 112 guides flexible elongated element 118 through housing 102. An end of flexible elongated element 118 extends away from housing 102 at opening 134, another end of flexible elongated element 118 extends away from housing 102 at opening 136, and a portion of flexible elongated element 118 is movably engaged within housing 102. The portion of flexible elongated element 118 extending away from housing 102 at opening 136 is herein after referred to as an end section of flexible elongated element 118. After an object has been secured to the end of flexible elongated element 118 extending away from housing 102 at opening 134 and removable securing element 138 extending through aperture 122 (or aperture 128) in housing 102 attaches tensioning device 100 to a substantially fixed object, the end section of flexible elongated element 118 is pulled in a general direction away from housing 102 at opening 136 until a desired tension is achieved in flexible elongated element 118. Next, as illustrated in FIG. 2, a portion of the end section proximate opening 136 is first placed within jamming cleat 108 and then secured within locking element 110 by placing flexible elongated element 118 into the space between housing 102 and locking arm 120. Accordingly, both flexible elongated element 118 and the object secured to the end of flexible elongated element 118 extending away from housing 102 at opening 134 are held under tension. The applied tension is relieved by performing the steps in the reverse order.

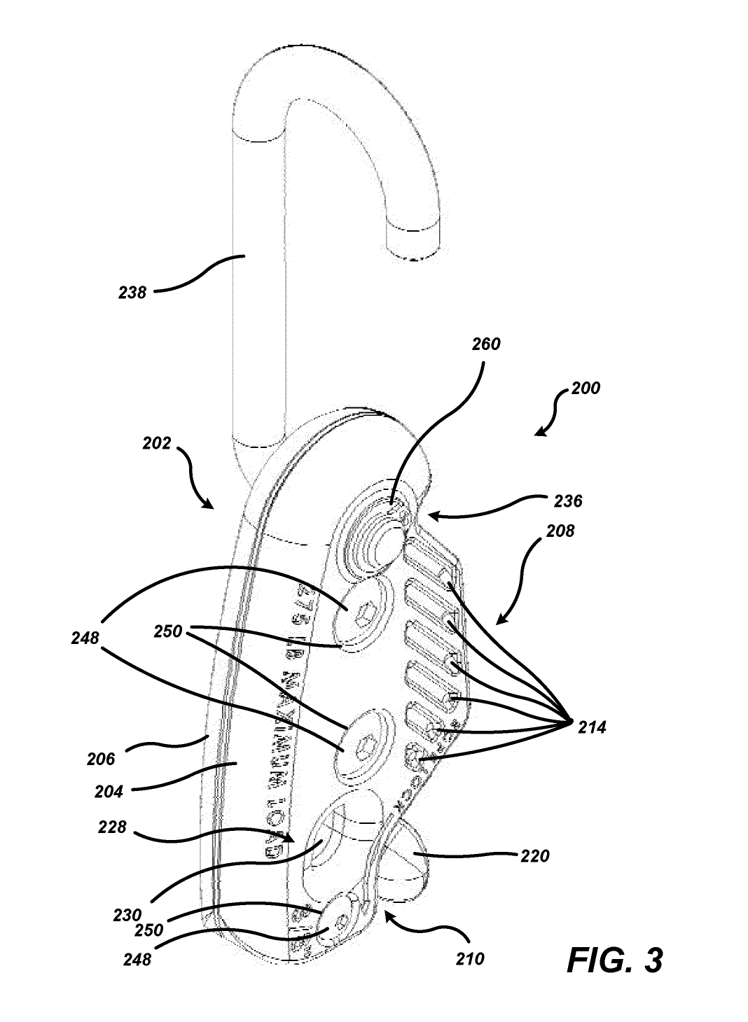

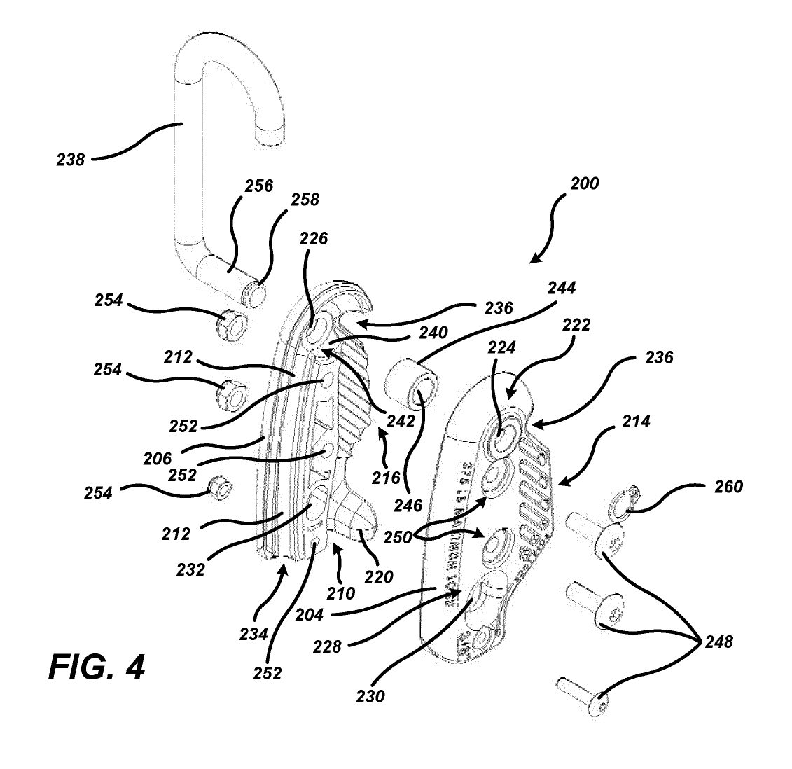

FIGS. 3 and 4, respectively, are perspective views of an assembled and a disassembled tensioning device 200 in accordance with an embodiment of the invention. Several components and features of tensioning device 200 are substantially similar to those of tensioning device 100 described herein above with reference to FIGS. 1 and 2. As illustrated in FIGS. 3 and 4, housing 202 of tensioning device 200 comprises two opposed walls 204 and 206. When assembled, opposed walls 204 and 206 together define jamming cleat 208, locking element 210 and channel 212 within housing 202. Jamming cleat 208 comprising a plurality of opposing ridges 214 and 216 in opposed walls 204 and 206, respectively, is configured for imparting a non-slip grip on a flexible elongated element (not shown) that is placed therewithin. Locking element 210 comprising locking arm 220 is configured for retaining the flexible elongated element within jamming cleat 208 upon placement of the flexible elongated element within the space between housing 202 and locking arm 220. Housing 202 further includes at least one aperture 222 extending therethrough, wherein aperture 222 is formed by aligned apertures 224 and 226 in opposed walls 204 and 206, respectively. As illustrated in FIG. 4, the inside surface of wall 206 includes indentation (or hollow) 240 around aperture 226. A complimentary indentation or hollow (not shown) on the inside surface of wall 204 around aperture 224 aligns with indentation 240 to define nest 242 for housing wheel 244. In an embodiment of the invention, the diameter of hub 246 of wheel 244 is essentially equal to the diameters of apertures 224 and 226 such that upon assembly of opposed walls 204 and 206, aperture 222 extending through housing 202 also extends through hub 246 of wheel 244. Alternate embodiments of tensioning device 200 include additional apertures extending through housing 202, such as aperture 228 formed by aligned apertures 230 and 232 in opposed walls 204 and 206, respectively.

As illustrated in FIG. 4, channel 212 extends through housing 202 between openings 234 and 236 and around the outside circumferential surface of wheel 244. As such, channel 212 functions as a passage for the flexible elongated element within housing 202 from the first opening 234, through an approximately 180° turn, to the second opening 236. As described herein below, movement of the flexible elongated element within channel 212 imparts a rotational movement on wheel 244.

As can be seen from FIGS. 3 and 4, opposed walls 204 and 206 have substantially complementary outer edges and form housing 202 when these outer edges are positioned against one another and opposed walls 204 and 206 are secured in place by fastening elements. As shown, bolts 248 extending through apertures 250 and 252 in opposed walls 204 and 206, respectively, are secured by nuts 254. Alternate fastening elements for forming housing 202 by securing opposed walls 204 and 206 in place are considered as falling within the spirit, scope and intent of the instant invention.

Securement elements, such as removable securing element 238 extending through aperture 222 in housing 202, are used for attaching tensioning device 200 to a substantially fixed object for the purpose of tensioning the flexible elongated element extending through housing 202. Securing element 238 includes substantially straight section 256 extending through both aperture 222 in housing 202 and hub 246 of wheel 244. As such, substantially straight section 256 of securing element 238 is essentially configured to function as an axle for wheel 244 around which wheel 244 rotates when the flexible elongated element moves within channel 212 and through housing 202. In an embodiment of the invention, tip (or end) 258 of substantially straight section 256 includes securement means well known in the art for inhibiting removal or disengagement of securing element 238 from aperture 222 of housing 202. As illustrated in FIG. 4, tip 258 comprises one or more circumferential ridges or indentations configured for securing clip 260 such as a spring clip or any other similar element. In an alternate embodiment, tip 258 is configured for securement with a pin such as a cotter pin, hair pin, clevis pin, and the like. In another embodiment, tip 258 is threaded for securement with a nut or other similar element. In another embodiment, tip 258 is configured for securement with a rivet. In some embodiments, the structure of tip 258 includes a feature (e.g., a crimp, a bend, etc.) that serve to secure the securement element 238 in place. Other structural features of the securing element can also serve the securement purpose. In an alternate embodiment of the invention, sliding movement of tensioning device 200 along substantially straight section 256 is limited (or restricted) by including at least two spaced apart securement means, similar to one or more of those described in the foregoing, on either side of housing 202. In another embodiments of the invention, the spaced apart securement means on either side of housing 202 are used for fixedly attaching tensioning device 200 to securing element 238 for inhibiting both rotational and translational movement of housing 202 relative to substantially straight section 256. In yet another embodiments of the invention, the spaced apart securement means on either side of housing 202 are used for attaching tensioning device 200 to securing element 238 such that rotational movement of housing 202 about substantially straight section 256 is permitted, however translational movement of housing 202 along substantially straight section 256 is inhibited. To one skilled in the art, additional securement means enabling alternate movements of housing 202 relative to securing element 238 will apparent. As shown in FIGS. 3 and 4, substantially straight section 256 of securing element 238 entering aperture 222 of housing 202 through aperture 226 in wall 206, extending through hub 246 of wheel 244, exiting aperture 222 of housing 202 through aperture 224 in wall 204, and retained in this configuration with the installment of clip 260 in tip 258 extending through wall 204. As it will be clearly apparent to one skilled in the art, the exemplary configuration for attaching housing 202 to securing element 238 illustrated in FIGS. 3 and 4 is reversible in that substantially straight section 256 of securing element 238 enters aperture 222 of housing 202 through aperture 224 in wall 204, extends through hub 246 of wheel 244, exits aperture 222 of housing 202 through aperture 226 in wall 206, and retained in this configuration with the installment of clip 260 in tip 258 extending through wall 206. Alternate securement means for attaching tensioning device 200 to a substantially fixed object are considered as falling within the spirit, scope and intent of the instant invention.

In use, channel 212 guides the flexible elongated element through housing 202. An end of the flexible elongated element extends away from housing 202 at opening 234, another end of the flexible elongated element extends away from housing 202 at opening 236, and a portion of the flexible elongated element is movably engaged within housing 202. The portion of the flexible elongated element extending away from housing 202 at opening 236 is herein after referred to as an end section of the flexible elongated element. After an object has been secured to the end of the flexible elongated element extending away from housing 202 at opening 234 and removable securing element 238 extending through both aperture 222 in housing 202 and hub 246 of wheel 244 attaches tensioning device 200 to a substantially fixed object, the end section of the flexible elongated element is pulled in a general direction away from housing 202 at opening 236 until a desired tension is achieved in the flexible elongated element. Next, as previously described in reference to FIG. 2, a portion of the end section proximate opening 236 is first placed within jamming cleat 208 and then secured within locking element 210 by placing the flexible elongated element into the space between housing 202 and locking arm 220. Accordingly, both the flexible elongated element and the object secured to the end of the flexible elongated element extending away from housing 202 at opening 234 are held under tension. The applied tension is relieved by performing the steps in the reverse order.

As will be apparent to one skilled in the art, substantially straight section 256 of securing element 238, when attached to housing 202 as described herein above, functions as an axle for wheel 244. In accordance with an embodiment of the invention, wheel 244 is dimensioned such that there is minimal contact between wheel 244 and any internal surface of housing 202, including any surface of nest 242, while substantially straight section 256 of securing element 238 extends through hub 246 of wheel 244. A portion of the flexible elongated element within channel 212 of housing 202 will be in contact with a portion of the outer circumferential surface of wheel 244 such that any movement of the flexible elongated element within channel 212 will impart a rotational movement on wheel 244 around substantially straight section 256 functioning as the axle for wheel 244. Referring back to the prior art embodiment illustrated in FIGS. 1 and 2, it is seen that at least a portion of aperture 122 shares a common surface with at least a portion of channel 112. As it will be apparent to one skilled in the art, this common surface between aperture 122 and channel 112 will impart a frictional resistance to the movement of flexible elongated element 118 within housing 102. As it will also be apparent to one skilled in the art, this friction resistance inherent in the prior art embodiment shown in FIGS. 1 and 2 is essentially eliminated with the incorporation of wheel 244 in the embodiment of the instant invention as illustrated in FIGS. 3 and 4. As can be seen, wheel 244 will rotate in conjunction with the movement of the flexible elongated element around aperture 222 in housing 202.

While the embodiment of the invention shown in FIGS. 3 and 4 illustrate a simple wheel 244 as the means for reducing friction, alternate configurations will be apparent to one skilled in the art. For instance, an alternate embodiment of the invention will incorporate a wheel with a locking mechanism which will permit the wheel to rotate in a first direction but not in a second direction opposite the first direction. One such locking mechanism that can be easily incorporated is a ratcheting mechanism as is well known in the art. As such, the wheel will rotate in conjunction with the movement of the flexible elongated element in the first direction; however, movement of the flexible elongated element in the second direction opposite the first direction will lock the wheel and impart frictional resistance between the circumferential surface of the wheel and the flexible elongated element. In some instances, the friction resistance resulting from the locked wheel and the movement of the flexible elongated element in the second direction can be substantial and, as such, can be advantageous when relieving the tension in the flexible elongated element. All wheel locking mechanisms and/or any combinations thereof are considered as falling within the spirit, scope and intent of the instant invention.

In accordance with an embodiment of the invention, wheel 244 functions as a pulley. In an alternate embodiment, wheel 244 comprises a groove between a pair of flanges around a circumference of the wheel wherein the flexible elongated element is housed within the groove. In another embodiment of the invention, the outer circumferential surface of wheel 244 includes a plurality of longitudinally or angularly extending ribs or ridges or grooves for providing the flexible elongated element a “grip” on the wheel. In yet another embodiment of the invention, the outer circumferential surface of wheel 244 comprises a non-smooth, for example a roughened, texture for enhancing a “grip” between the flexible elongated element and the wheel. Combinations of one or more of such design considerations and/or other means for reducing friction will be apparent to one skilled in the art. All such configurations are considered as falling within the spirit, scope and intent of the instant invention.

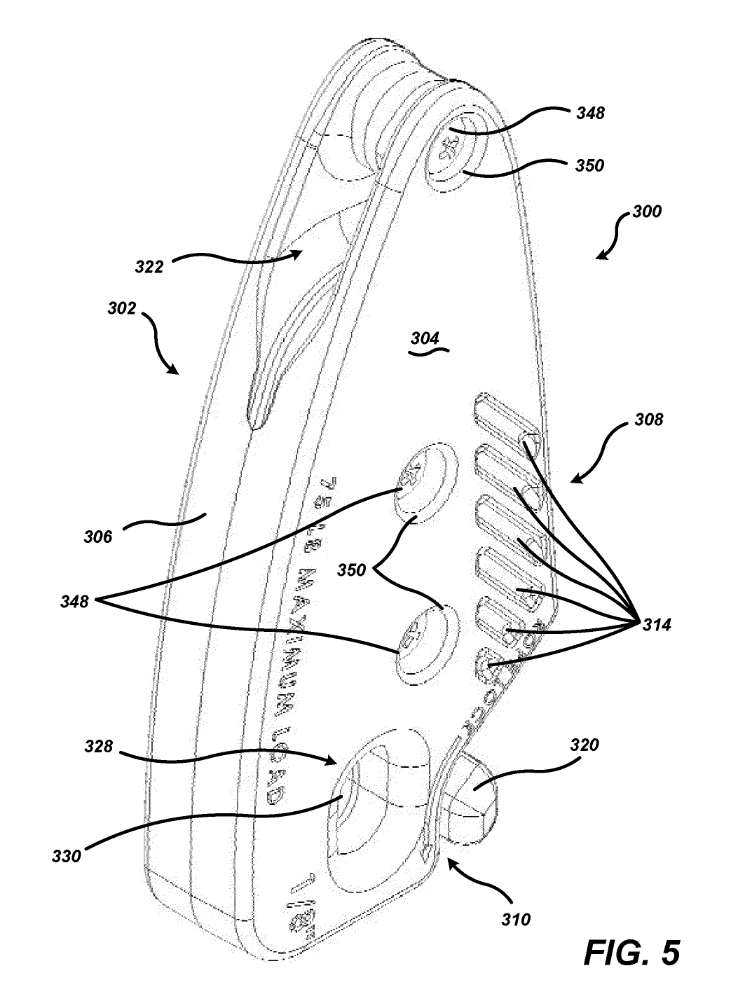

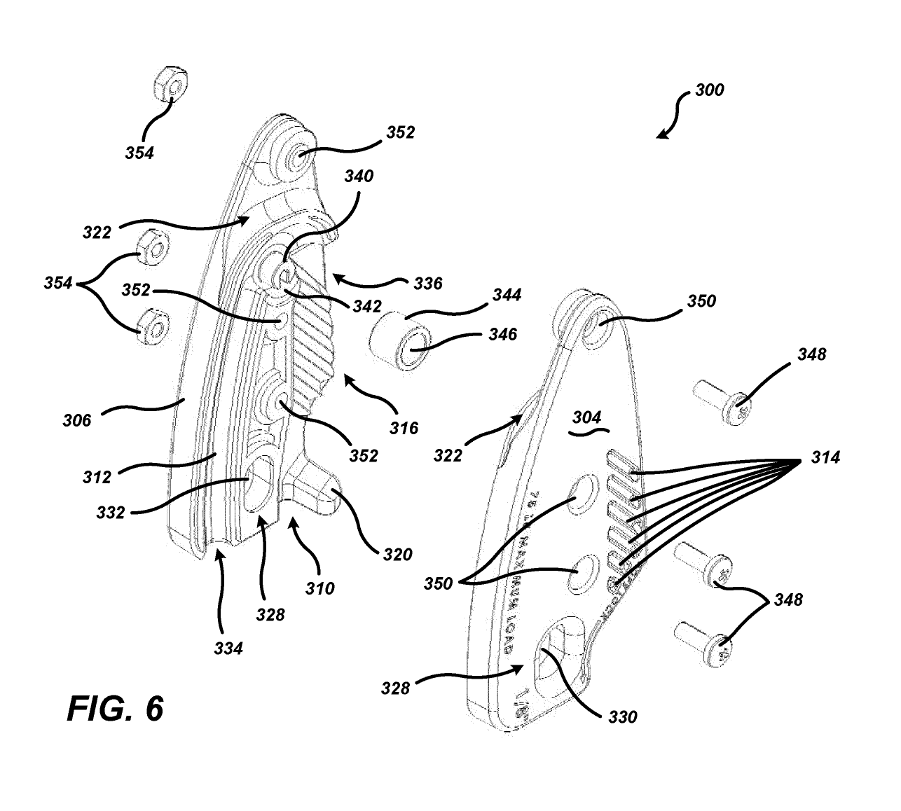

FIGS. 5 and 6, respectively, are perspective views of an assembled and a disassembled tensioning device 300 in accordance with another embodiment of the invention. Several components and features of tensioning device 300 are substantially similar to those of tensioning device 200 described herein above with reference to FIGS. 3 and 4. As illustrated in FIGS. 5 and 6, housing 302 of tensioning device 300 comprises two opposed walls 304 and 306. When assembled, opposed walls 304 and 306 together define jamming cleat 308, locking element 310 and channel 312 within housing 302. Jamming cleat 308 comprising a plurality of opposing ridges 314 and 316 in opposed walls 304 and 306, respectively, is configured for imparting a non-slip grip on a flexible elongated element (not shown) that is placed therewithin. Locking element 310 comprising locking arm 320 is configured for retaining the flexible elongated element within jamming cleat 308 upon placement of the flexible elongated element within the space between housing 302 and locking arm 320.

As illustrated in FIG. 6, the inside surface of wall 306 includes cylindrical extension 340 with clearance 342 therearound for housing wheel 344. A complimentary cylindrical extension on the inside surface of wall 304 aligns with cylindrical extension 340 to define an axle for hub 346 of wheel 344. Additionally, a complementary clearance around the complimentary cylindrical extension on the inside surface of wall 304 aligns with clearance 342 to define a housing for wheel 344. The cylindrical extensions, the clearances around the cylindrical extensions, wheel 344 and hub 346 are all dimensioned for ensuring smooth rotation of wheel 344 around the axle formed by the cylindrical extensions and within the housing formed by the clearances around the cylindrical extensions. In accordance with an embodiment of the invention, wheel 344 is dimensioned such that there is minimal contact between the outer circumferential surface of wheel 344 and any internal surface of housing 302, including any surfaces of the wheel housing formed by complimentary clearances such as clearance 342. Other means for supporting wheel 344 may involve a separate metal shaft rather than the cylindrical extensions, along with other structures known by those of ordinary skill in the art.

Housing 302 includes one or more apertures 322 and 328 for attaching tensioning device 300 to a removable securing element (not shown) such as securing elements 138 and 238 as described in the foregoing with reference to FIGS. 1-4. Aperture 322 is defined between opposed walls 304 and 306 when housing 302 is formed. As shown, aperture 328 extending through housing 302, is formed by aligned apertures 330 and 332 in opposed walls 304 and 306, respectively.

As illustrated in FIG. 6, channel 312 extends through housing 302 between openings 334 and 336 and around the outside circumferential surface of wheel 344. As such, channel 312 functions as a passage for the flexible elongated element within housing 302 from the first opening 334, through an approximately 180° turn, to the second opening 336. Movement of the flexible elongated element within channel 312 imparts a rotational movement on wheel 344. As can be seen, a portion of the flexible elongated element within channel 312 of housing 302 will be in contact with a portion of the outer circumferential surface of wheel 344 such that any movement of the flexible elongated element within channel 312 will impart a rotational movement on wheel 344 around the complimentary cylindrical extensions. As previously described, the complimentary cylindrical extensions, such as cylindrical extension 340 on the inside surface of wall 306, form an axle for wheel 344. Referring back to the prior art embodiment illustrated in FIGS. 1 and 2, it is seen that at least a portion of aperture 122 shares a common surface with at least a portion of channel 112. As it will be apparent to one skilled in the art, this common surface between aperture 122 and channel 112 will impart a frictional resistance to the movement of flexible elongated element 118 within housing 102. As it will also be apparent to one skilled in the art, this friction resistance inherent in the prior art embodiment shown in FIGS. 1 and 2 is essentially eliminated with the incorporation of wheel 344 in the embodiment of the instant invention as illustrated in FIGS. 5 and 6. As can be seen, wheel 344 will rotate in conjunction with the movement of the flexible elongated element around the complimentary cylindrical extensions on the inside surfaces of opposed walls 304 and 306 of housing 302.

As can be seen from FIGS. 5 and 6, opposed walls 304 and 306 have substantially complementary outer edges and form housing 302 when these outer edges are positioned against one another and opposed walls 304 and 306 are secured in place by fastening elements. As shown, bolts 348 extending through apertures 350 and 352 in opposed walls 304 and 306, respectively, are secured by nuts 354. Alternate fastening elements for forming housing 302 by securing opposed walls 304 and 306 in place are considered as falling within the spirit, scope and intent of the instant invention.

Securement elements, such as removable securing elements 138 and 238 described in the foregoing with reference to FIGS. 1-4, extending through one or more apertures, such as apertures 322 and 328 in housing 302, are used for attaching tensioning device 300 to a substantially fixed object for the purpose of tensioning the flexible elongated element extending through housing 302. In some preferred embodiments, a carabineer can be extended through aperture 322 to serve as the securing element. As previously stated, alternate securement means for attaching tensioning device 300 to a substantially fixed object are considered as falling within the spirit, scope and intent of the instant invention. Embodiments like those shown in FIGS. 5-6 6 can be advantageous in that the securing element does not affect the movement of the flexible elongated element relative to the wheel 344.

In use, channel 312 guides the flexible elongated element through housing 302. An end of the flexible elongated element extends away from housing 302 at opening 334, another end of the flexible elongated element extends away from housing 302 at opening 336, and a portion of the flexible elongated element is movably engaged within housing 302. The portion of the flexible elongated element extending away from housing 302 at opening 336 is herein after referred to as an end section of the flexible elongated element. After a securement element attaches tensioning device 300 to a substantially fixed object and an object has been secured to the end of the flexible elongated element extending away from housing 302 at opening 334, the end section of the flexible elongated element is pulled in a general direction away from housing 302 at opening 336 until a desired tension is achieved in the flexible elongated element. Next, as previously described in reference to FIGS. 2 and 4, a portion of the end section proximate opening 336 is first placed within jamming cleat 308 and then secured within locking element 310 by placing the flexible elongated element into the space between housing 302 and locking arm 320. Accordingly, both the flexible elongated element and the object secured to the end of the flexible elongated element extending away from housing 302 at opening 334 are held under tension. The applied tension is relieved by performing the steps in the reverse order.

While the embodiment of the invention shown in FIGS. 5 and 6 illustrate a simple wheel 344, alternate wheel configurations will be apparent to one skilled in the art. For instance, and as previously described in the foregoing with reference to wheel 244 in the embodiment illustrated in FIGS. 3 and 4, an alternate embodiment of the invention will incorporate a wheel with a locking mechanism which will permit the wheel to rotate in a first direction but not in a second direction opposite the first direction. All alternate wheel locking mechanisms and/or any combinations thereof are considered as falling within the spirit, scope and intent of the instant invention.

In accordance with an embodiment of the invention, wheel 344 functions as a pulley similar to wheel 244. Alternate embodiments of the means for reducing friction, such as those previously described as alternate embodiments for wheel 244, are considered as falling within the spirit, scope and intent of the instant invention. Exemplary embodiments for wheel 344 comprise a groove between a pair of flanges around a circumference of the wheel, a plurality of longitudinally or angularly extending ribs or ridges or grooves on the outer circumferential surface of the wheel, non-smooth or roughened outer circumferential surface, etc. All such variations are considered as falling within the spirit, scope and intent of the instant invention.

Various modifications and additions may be made to the exemplary embodiments described hereinabove without departing from the scope, intent and spirit of the instant invention. For example, while the disclosed embodiments refer to particular features, the scope of the instant invention is considered to also include embodiments having various combinations of features different from and/or in addition to those described hereinabove. Accordingly, the present invention embraces all such alternatives, modifications, and variations as within the scope, intent and spirit of the appended claims, including all equivalents thereof.

We claim:

1. A device for holding a flexible elongated element under tension, said device comprising:
a housing comprising first and second opposed side walls;
a channel within said housing, said channel
defined between said first and second opposed side walls;
extending around a wheel between first and second openings in said housing; and
configured for guiding said flexible elongated element through said housing and around said wheel when a portion of said flexible elongated element moves between said first and second openings;
a jamming cleat configured for receiving and engaging said flexible elongated element extending through said channel;
a locking element configured for inhibiting disengagement of said flexible elongated element engaged within said jamming cleat; and
an aperture extending through said housing, said aperture configured for receiving a removable securing element extending through said housing for attaching said device to a substantially fixed object.

2. The device of claim 1, wherein a hub of said wheel rotatably engages opposing
cylindrical extensions, said cylindrical extensions
extending from said first and second opposed side walls; and
aligned to function as an axle for said wheel.

3. The device of claim 1, wherein said aperture aligns with a hub of said wheel nested between said first and second opposed side walls and wherein said securing element extending through said housing rotatably engages the hub of said wheel and functions as an axle for said wheel.

4. The device of claim 1, wherein a movement of said flexible elongated element between said first and second openings imparts a rotational movement on said wheel such that there is essentially no slippage between said wheel and said flexible elongated element.

5. The device of claim 4, further comprising a wheel locking mechanism configured for
permitting said wheel to rotate essentially uninhibited in a first direction in conjunction with a movement of said flexible elongated element in said first direction such that there is essentially no slippage between said wheel and said flexible elongated element; and
inhibiting said wheel to rotate in a second direction opposite said first direction, thereby impairing movement of said flexible elongated element in said second direction.

6. The device of claim 1, further comprising two or more apertures extending through said housing wherein each aperture is configured for receiving at least one additional removable securing element extending through said housing.

7. The device of claim 6, wherein each securing element comprises at least one retention mechanism configured for inhibiting removal of said securing element from said aperture, said retention mechanism selected from the group consisting of spring clip, cotter pin, hair pin, clevis pin, nut, rivet, and securing element structural feature.

8. The device of claim 6, wherein each securing element comprises at least two retention mechanisms with at least one of said retention mechanisms on each side of said housing such that movement of said device is restricted to between said retention mechanisms, said retention mechanisms selected from the group consisting of spring clip, cotter pin, hair pin, clevis pin, nut, rivet, and securing element structural feature.

9. The device of claim 1, wherein said wheel is a pulley and said device is part of a configuration selected from the group consisting of block, tackle, and block and tackle.

10. A method of using a device for holding a flexible elongated element under tension, said method comprising:
providing said device comprising
a housing comprising first and second opposed side walls;
a channel within said housing, said channel
defined between said first and second opposed side walls;
extending around a wheel between first and second openings in said housing; and
configured for guiding said flexible elongated element through said housing and around said wheel when a portion of said flexible elongated element moves between said first and second openings;
a jamming cleat configured for receiving and engaging said flexible elongated element extending through said channel;
a locking element configured for inhibiting disengagement of said flexible elongated element engaged within said jamming cleat; and
an aperture extending through said housing;
extending a removable securing element through said aperture in said housing and attaching said device to a substantially fixed object;
inserting an end of said flexible elongated element through said first opening;
feeding said end of said flexible elongated element through said channel and around said wheel;
extracting said end of said flexible elongated element through said second opening;
tensioning said end of said flexible elongated element and extracting a portion of said flexible elongated element through said second opening until a desired tension is achieved; and
engaging said portion of said flexible elongated element extracted through said second opening in said jamming cleat first, next relaxing said tensioning on an end section of said flexible elongated element, and then engaging said end section in said locking element, wherein said end section is that portion of said flexible elongated element between said end and said jamming cleat.

11. The method of claim 10, comprising affixing a load to a portion of said flexible elongated element extending from said first opening and external to said housing, wherein said load is affixed before the steps of tensioning, engaging and relaxing.

12. The method of claim 11, wherein the step of tensioning precedes the steps of engaging and relaxing.

13. The method of claim 11, comprising operating said device as part of a configuration selected from the group consisting of block, tackle, and block and tackle.

14. The method of claim 11, comprising releasing said flexible elongated element from tension by first disengaging said end section from said locking element and then disengaging said flexible elongated element from said jamming cleat.

15. The method of claim 10, comprising imparting a rotational movement on said wheel in conjunction with a movement of said flexible elongated element between said first and second openings such that there is essentially no slippage between said wheel and said flexible elongated element.

16. The method of claim 10, wherein said device comprises a wheel locking mechanism configured for
permitting said wheel to rotate essentially uninhibited in a first direction in conjunction with a movement of said flexible elongated element in said first direction such that there is essentially no slippage between said wheel and said flexible elongated element; and
inhibiting said wheel to rotate in a second direction opposite said first direction, thereby impairing movement of said flexible elongated element in said second direction.

17. A device for holding a flexible elongated element under tension, said device comprising:
a housing comprising first and second opposed side walls;
a channel within said housing, said channel
defined between said first and second opposed side walls;
extending from a first opening in said housing, through an approximately 180° turn, to a second opening in said housing; and
including means for reducing friction as a portion of said flexible elongated element moves from said first opening to said second opening;
a jamming cleat configured for receiving and engaging said flexible elongated element extending through said channel;
a locking element configured for inhibiting disengagement of said flexible elongated element engaged within said jamming cleat; and
an aperture extending through said housing, said aperture configured for receiving a removable securing element extending through said housing for attaching said device to a substantially fixed object.

18. The device of claim 17, wherein said means for reducing friction comprises a wheel, wherein a hub of said wheel rotatably engages means for supporting said wheel.

19. The device of claim 17, wherein means for reducing friction is nested between said first and second opposed side walls.

20. The device of claim 17, wherein a movement of said flexible elongated element between said first and second openings imparts a rotational movement on said means for reducing friction such that there is essentially no slippage between said means for reducing friction and said flexible elongated element.
